(19) United States
(12) Patent Application Publication
(10) Pub. No.: US 2014/0073037 A1
(43) Pub. Date: Mar. 13, 2014

(54) METHOD FOR EXTRACTING SQUALENE FROM MICROALGAE

(71) Applicant: Samuel Patinier, Lille (FR)

(72) Inventor: Samuel Patinier, Lille (FR)

(73) Assignee: ROQUETTE FRERES, LESTREM (FR)

(21) Appl. No.: 14/118,674

(22) PCT Filed: May 25, 2012
(86) PCT No.: PCT/FR2012/051175

§ 371 Date: Nov. 19, 2013

(30) Foreign Application Priority Data
May 27, 2011 (FR) 1154623

(51) Int. Cl. C11B 1/02

(52) U.S. Cl. CPC C11B 1/025
USPC 435/267

(57) ABSTRACT

The invention relates to a method for extracting, without using an organic solvent, squalene produced by fermenting microalgae belonging to the Thraustochytriales sp. family, characterised in that it includes the following steps: 1) preparing a biomass of microalgae belonging to the Thraustochytriales family so as to reduce the concentration of interstitial soluble matter, and to thereby achieve a purity of 30 to 99% expressed as the dry weight of biomass over the total dry weight of the fermentation medium; 2) treating the resulting biomass using a protease enzyme selected from the group of neutral or basic proteases, so as to break the cell wall of said microalgae while preventing the formation of the emulsion produced by said enzyme treatment; 3) centrifuging the resulting reaction mixture in order to separate the oil from the aqueous phase; and 4) recovering the thus-produced crude oil rich in squalene.

### The present invention relates to a process for the optimized extraction of squalene, without organic solvent, from microalgae of the Thraustochytriales sp. family.

For the purposes of the invention, the expression “microalgae of the Thraustochytriales sp. family” is intended to mean microalgae belonging to the Schizochytrium sp., Aurantiochytrium sp. and Thraustochytrium sp. species,

Squalene is a triterpene, an isoprenoid comprising 30 carbon atoms and 50 hydrogen atoms, of formula: 2,6,10,15,19,23-hexamethyl-2,6,10,14,18,22-tetracosa-hexene.

It is a lipid that is naturally produced by all higher organisms, including in human beings (found in sebum). Squalene is in fact an essential intermediate in the biosynthesis of cholesterol, steroid hormones and vitamin D (an enzyme of the cholesterol metabolic pathways, squalene monooxygenase, will, by oxidizing one of the ends of the squalene molecule, induce cyclization thereof and result in lanosterol, which will be converted to cholesterol and to other steroids).

Industrially, squalene is especially used in the food sector, the cosmetics field and the pharmaceutical field.

As a food supplement, squalene is usually formulated as capsules or as oils.

In the cosmetics field, this molecule can be used as an antioxidant, an antistatic and an emollient in moisturizing creams, penetrating the skin rapidly without leaving fatty traces or sensations, and mixing well with other oils and vitamins.

In this field, it should be noted that, given the very high instability of squalene (6 unsaturation), it is the saturated form squalane (obtained by hydrogenation), a better antioxidant than squalene, which is found on the market, generally with a very high level of purity (99%).

Toxicological studies have shown that, at the concentrations used in cosmetics, squalene and squalane do not exhibit any toxicity, and are not irritant or sensitizing to human skin.

In the pharmaceutical field, squalene is used as adjuvants for vaccines.

These adjuvants are substances which stimulate the immune system and increase the response to the vaccine.

The level of purity of the squalene is essential in this field of application.

Indeed, if it is taken orally, squalene is considered to be completely safe; however, the injectable route is the subject of controversy.

Indeed, in the medical field, the risk, of harm, for a human recipient may be increased in situations where the squalene is contaminated with impurities, since, by definition, this adjuvant can induce a strong immune response also against its own impurities.

It is therefore essential to have high-quality squalene free of impurities (traces of metals, in particular of mercury, and of other toxins).

A certain number of pathways for producing and extracting squalene are proposed in the literature.

It is a compound which is often found stored in the liver of cartilaginous fish such as deep sea sharks (hence its name).

It is therefore one of the reasons why they are overfished, the shark already being hunted, for its fins. Shark livers are thus now sold to produce gel capsules described as “good for the health”.

However, while the squalene marketed is thus mainly extracted from shark livers, it is not free of health problems.

This is because sharks can be infected with pathogens that can produce substances harmful to human beings. In addition, the shark liver, which is the organism's elimination and purification organ, may contain toxins such as carchatoxin which is harmful to human beings.

These environmental concerns (large decrease in shark numbers) and health concerns (fish liver also stores toxins that are of concern with regard to health) have prompted its extraction from plants.

It is thus possible to isolate it from olive oil and palm oil, and in other oils from cereals or originating from amaranth, seeds, rice bran or wheat germ.

However, the major drawback in this case is that the squalene is extracted in very small amounts, of about from 0.1% to 0.7% by weight.

As a first alternative to these processes of extraction from shark livers or from plants, often made expensive by the implementation of substantial enrichment and purification processes, the first processes for producing squalene from microorganisms: natural yeasts or recombinant yeasts, in particular of Saccharomyces type, have been proposed.

Thus, Saccharomyces cerevisiae is known for its ability to produce squalene, however in very small amounts: of about 0.041 mg/g of biomass (Bhattacharjee, P. et al., 2001, in World J. Microb. Biotechnol., 17, pp. 811-816).

Work has therefore been carried out on the optimization of these production capacities, by means of genetic recombination. However, as presented by patent application WO 2010/023551 for the medical field (production of squalene with a purity greater than 97% as vaccine adjuvant), this first alternative is industrializable only if it is possible to have recombinant yeasts hyperproducing squalene (at more than 15% by weight of dry cells).

As it happens, the obtaining of these recombinant cells requires the implementation of numerous laborious, lengthy and complex metabolic engineering steps, using molecular biology tools, resulting in the stimulation of the squalene biosynthesis pathways and in the inhibition of the squalene catabolism pathways.

As a second alternative to the processes of extraction from shark livers or from plants, promising processes for producing squalene from microalgae of the Thraustochytriales family (comprising the genera Thraustochytrium, Aurantiochytrium and Schizochytrium), more particularly Schizochytrium mangrovei or Schizochytrium limacinum, have been proposed.

These microalgae produce squalene under heterotrophic conditions (absence of light; provision of glucose as carbon source), and can therefore be easily manipulated by those skilled in the art in the field of microorganism fermentation.

These processes therefore offer, by means of controlled fermentation conditions, qualities of squalene of which the purification is easily conceivable to meet food, cosmetic and medical needs.

In these microalgae of the Thraustochytriales family, squalene is, however, the coproduct of other lipid compounds of interest, such as docosahexaenoic acid, (or DHA), a polyunsaturated fatty acid of the ω3 family.

It thus appears that squalene is especially described as one of the components of the unsaponifiable fraction of commercial DHA oils (along with carotenoids and sterols).

By way of comparison, the Schizochytrium mangrovei FB1 strain produces DHA in a proportion of 6.2% by dry weight of cells, for 0.017% of squalene.

As a result, these microorganisms which naturally produce squalene, do so in small amounts:
of about 0.1 mg/g of biomass, for Thraustochytrid ACEM 6063 (cf. Lewis et al., Mar. Biotechnol., 2001, pp 439-447),
of about 0.162 mg/g of biomass, for Schizochytrium mangrovei FB1 (cf. Yue Jiang et al., J. Agric. Food Chem., 2004, 52, pp 1196-1200).

In order to increase these productions, it therefore appeared to be essential to optimize the fermentation conditions.

However, despite all the efforts made, these values remain lower than the reference values for olive oil (of about 4.24 mg/g).

At best, these optimized productions result in the production of about:
1 mg to 1.2 mg of squalene per g of Thraustochytrid ACEM 6063 biomass (cf. Qian Li et al., J. Agric. Food Chem., 2009, 57, 4267-4272 or Lewis et al., in Mar. Biotechnol., 2001, 3, 439-447);
0.72 mg of squalene per g of Schizochytrium biomass (cf, G. Chen et al., New Biotechnology, 2010, 27-4, pp 382-389);
0.53 mg of squalene per g of Aurantiochytrium mangrovei FB3I biomass (cf. K. W. Fan et al., World J. Microbiol. Biotechnol., 2010, 26-3, pp 1303-1309);
1.17±0.6 mg of squalene per g of Schizochytrium mangrovei biomass (cf. C-J Yue and. Y. Jiang, Process Biochemistry, 2009, 44, 923-927).

The applicant company has itself also contributed, to further improving the production of squalene by microalgae of the Thraustochytriales sp. family by providing a process which makes it possible to produce squalene at a level never yet reached in the literature in the field, i.e. of at least 8 g of squalene per 100 g of biomass (as will be exemplified hereinafter).

On a laboratory scale, the methods for extracting squalene from the biomass resulting from fermentation media are conventionally methods using organic solvents:
Yue Jiang et al., J. Agric. Food Chem., 2004, 52, 1196-1200 describe a process in which the lipids are solubilized in methanol/acetone (7:3 v/v) and then washed in chloroform/methanol (2:1 v/v);
in C-J Yue and Y. Jiang, Process Biochemistry, 2009, 44, 923-927, the extraction of squalene and cholesterol is carried out with hexane after prior saponification with ethanol of the lyophilized cells;
in G. Chen et al., in New Biotechnology, 2010, 27-4, pp 382-389, the extraction of the squalene is carried out with hexane after saponification with KOH (10% w/v)-ethanol (75% v/v) of the lyophilized cells;
in Lewis et al., Mar. Biotechnol., 2001, 439-447, the total lipids are first extracted, from the lyophilized cells using a ternary chloroform/methanol/water (1:2:0.8 v/v/v) mixture, and then, in order to obtain the unsaponifiable lipids, a part of these total lipids is treated with a 5% solution of KOH in methanol/water (4:1 w/v), followed by actual, extraction of the neutral unsaponifiable lipids with hexane-chloroform (4:1 v/v).

On a larger scale, in order to avoid the use of solvents harmful to human beings and to the environment, other solutions have been proposed.

Anecdotally, in patent KR 2008/0017960, it is proposed, for example, to place the medium containing squalene in a solution of cyclodextrins so as to obtain cyclodextrin/squalene complexes, and then to add a coagulation agent, such as CaCl₂, CaSO₄, MgCl₂ or MgSO₄, in order to facilitate its separation from said medium. However, it is also necessary to decomplex the squalene in order to isolate it as such.

However, in fact, two technologies are mainly described:
processes for extraction with supercritical CO₂;
processes for extraction in the absence of organic solvents.

The first alternative to processes for extraction with chloroform or with hexane is therefore supercritical CO₂.

This technology is well suited to the extraction of nonpolar compounds having a molecular weight of less than 500 Daltons (that of squalene is slightly below 400 Da).

Squalene is soluble in supercritical CO₂ at a pressure between 100 and 250 bar.

A great deal of work on extraction with this technology has been undertaken on Botryococcus braunii, Scenedesmus obliquus or Torulaspora delbrueckii.

Supercritical CO₂ is, moreover, thus used both for cell lysis and for the isolation of squalene.

However, it is recommended to lyophilize the cells before extracting the lipids therefrom, which requires a lot of additional work to adapt the techniques to the type of microorganism.

Moreover, these conditions are difficult to transpose to an industrial scale at attractive costs.

The second technological alternative is that of lipid extraction in the absence of organic solvents.

The teachings taken from the numerous articles and documents by Benemann and Oswald, or from, for example, patents EP 1 252 324 and EP 1 305 440, describe this approach, but without any of them specifying the optimized conditions for the extraction of squalene.

In their 1996 article entitled Systems and Economic Analysis of Microalgae Ponds for Conversion of CO2 to Biomass. Report prepared for the Pittsburgh Energy Technology Center under Grant No. DE-FG22-93PC93204, J. Benemann & W. Oswald teach that centrifugation can be used not only to concentrate the biomass, but also to simultaneously extract the lipids from the algae in an oil phase.

This separation is based on the relatively large difference in density between water, the lipids of the algae and the other constituents of the biomass.

Oswald & Benneman describe it especially in the context of a process for the extraction of beta-carotene from the algal biomass that has been flocculated by means of a hot oil extraction process.

Thus, the harvesting and treatment steps overlap, with the common flocculation and centrifugation steps.

Patent EP 1 252 324 reports disruption of the wet microbial biomass to release the intracellular lipids, treatment of cell lysate by means of a process for producing a “phase-separated mixture” comprising a heavy layer and a light layer, gravity separation of the heavy layer from the lipid-containing light layer, and then breaking of the water/lipid emulsion in said light phase in order to obtain the lipids.

It is important to note that the emulsion state prevents the recovery of pure lipids. It is therefore necessary to have recourse to a process of washing the emulsion with a washing solution, which may be water, alcohol and/or acetone, until the lipids become “substantially” non-emulsified. It is, however, recommended not to use more than 5% of nonpolar organic solvent.

It is also understood that the oil/water interface of the emulsion is stabilized by the cell debris. This is the reason why the heating of the fermentation medium before or during the cell-breaking step, or the addition of a base to the fermentation medium during the cell-breaking step, contributes to reducing the formation of the emulsion, since this heat (at least 50° C.) or alkaline treatment denatures the proteins and solubilizes the organic matter.

This process is said to allow the extraction of all types of lipids: phospholipids; free fatty acids; fatty acid esters, including fatty acid triglycerides; sterols; pigments (e.g. carotenoids and oxy-carotenoids) and other lipids, and lipid-associated compounds such as phytosterols, ergothionine, lipoic acid, and antioxidants including beta-carotene, tocotrienols and tocopherol.

The preferred lipids and lipid-associated compounds are in this case cholesterol, phytosterols, desmosterols, tocotrienols, tocopherols, ubiquinones, carotenoids and xanthophylls such as beta-carotene, lutein, lycopene, astaxanthin, zeaxanthin, canthaxanthin, and fatty acids such as conjugated linoleic acids, and polyunsaturated fatty acids of omega-3 and omega-6 type, such as eicosapentaenoic acid, docosapentaenoic acid, docosahexaenoic acid, arachidonic acid, stearidonic acid, dihomo-gamma-linolenic acid and gamma-linolenic acid.

Squalene is not envisioned as such, nor is any specific cell lysis process or conditions for carrying out the centrifugation explicitly provided. As for patent EP 1 305 440, it is especially dedicated to the extraction of arachidonic acid produced by Mortierella alpina.

Concerned with developing a process for extracting squalene which is more effective than those described in the prior art, the applicant company has developed its own research on the optimization of the conditions for extraction, without organic solvent, of this compound from fermentation media of microalgae of the Thraustochytriales sp. family.

The invention therefore relates to a process for extracting, without organic solvent, squalene produced by fermenting microalgae belonging to the Thraustochytriales sp. family, characterized in that it comprises the following steps:
1) preparing a biomass of microalgae belonging to the Thraustochytriales family so as to reduce the concentration of interstitial soluble matter, and to thus achieve a purity of between 30% and 99%, preferably greater than 95% expressed as the dry weight of biomass over the total dry weight of the fermentation medium,
2) treating the resulting biomass using a protease enzyme selected from the group of neutral or basic proteases, for example Alcalase, so as to break the cell wall of said microalgae while preventing the formation of the emulsion produced by said enzymatic treatment,
3) centrifuging the resulting reaction mixture in order to separate the oil from the aqueous phase, and
4) recovering the squalene-enriched crude oil thus produced.

The first step of the process according to the invention consists in preparing a biomass of microalgae belonging to the Thraustochytriales family so as to reduce the concentration of interstitial soluble matter and to thus achieve a purity of between 30% and 99%, preferably greater than 95% expressed as the dry weight of biomass over the total dry weight of the fermentation medium.

For the purposes of the invention, the term “interstitial soluble matter” is intended to mean all the soluble organic contaminants of the fermentation medium, e.g. the water-soluble compounds such as the salts, the residual glucose, the proteins and peptides, etc.

As microalgae belonging to the Thraustochytriales family, the following commercially available strains have been tested:
Schizochytrium sp. referenced ATCC 20888,
Aurantiochytrium sp. referenced ATCC PRA 276.

Moreover, the applicant company also has its own production strain, a Schizochytrium sp, deposited on Apr. 14, 2011, in France with the Collection Nationale de Cultures de Microorganismes [National Collection of Microorganism Cultures] of the Institut Pasteur under No. CNCM I-4469 and also deposited in China with the CHINA CENTER FOR TYPE CULTURE COLLECTION of the University of Wuhan, Wuhan 430072, P. R. China, under No. M 209118.

The culturing is carried out under heterotrophic conditions. Generally, the culturing step comprises a preculturing step, in order to revive the strain, and then a step of culturing or of fermentation per se. The latter step corresponds to the step of producing the lipid compounds of interest.

The conditions for culturing these microalgae are well known in the field. For example, the article by G. Chen in New Biotechnology 2010, 27-4, pp 382-389, describes a process comprising the following successive steps:
start from the strain maintained on agar nutritive medium, comprising glucose, mono sodium glutamate, yeast extract, and various trace elements,
prepare a preculture in Erlenmeyer flasks on an orbital shaker, at a pH of 6, at a temperature of 25° C. in order to obtain a revived biomass,
inoculate another series of production Erlenmeyer flasks with the same culture medium as that used in the preculture, with approximately 0.5% (v/v) of the biomass obtained in the previous step, and maintaining the temperature at 25° C.

The preculturing may preferably last from 24 to 74 hours, preferably approximately 48 hours. The culturing, for its part, may preferably last from 60 to 150 hours.

The carbon source required for the growth of the microalga is preferentially glucose.

With regard to the nature of the nitrogen source, the applicant company has found that it is possible to select this from the group consisting of yeast extracts, urea, sodium glutamate and ammonium sulfate, taken alone or in combination. Likewise, it is possible to totally or partially replace the urea with sodium glutamate, or to use a mixture of sodium glutamate and. ammonium sulfate.

It is possible to prefer to the yeast extracts, conventionally used in the prior art processes, urea supplemented with a vitamin cocktail, such as the BME cocktail sold by the company Sigma, used in a proportion of 5 ml/l.

Preferably, the preculture media comprise vitamins B1, B6 and B12.

With regard to the pH of the culture medium, as will be exemplified, hereinafter, it will be maintained between 5.5 and 6.5, preferentially fixed, at a value of 6. The pH can be regulated by any means known to those skilled in the art, for example by adding 2 N sulfuric acid, and then with 8 N sodium hydroxide.

Finally, the dissolved oxygen content can be regulated at a value between 20% and 0%, preferably maintained at 5% for an initial period between 24 and 48 hours, preferably 36 hours, before being left at 0%. With regard to the oxygen transfer, it will be regulated by any means known, moreover, to those skilled in the art, so as not to exceed 45 mmol/l/hour.

In accordance with the process of the invention, the biomass extracted from the fermenter is treated to achieve a purity greater than 95%, expressed as the dry weight of biomass over the total dry weight of the fermentation medium, by any means known to those skilled in the art.

Advantageously, the applicant company recommends washing the interstitial soluble matter via a succession of concentration (by centrifugation)/dilution of the biomass, as will be exemplified hereinafter.

This biomass thus purified of its interstitial soluble matter is then preferentially adjusted to a dry matter content of between 6% and 12%, preferably to a dry matter content of between 10% and 12%, with demineralized or purified water, preferably purified water.

The second step of the process in accordance with the invention consists in treating the resulting biomass using a protease enzyme selected from the group of neutral or basic proteases, for example Alcalase, so as to break the cell wall of said microalgae while preventing the formation of the emulsion produced by said enzymatic treatment.

As a preliminary to this step of enzymatic lysis of the cell wall, the biomass with a 12% dry matter content is placed in a reactor equipped with a propeller stirrer (low shear) and baffles (in order to disrupt the vortex effect produced) so as to limit the emulsification of the cell lysate that will be generated by the enzymatic treatment, while enabling homogeneous mixing promoting the action of the lytic enzyme.

The temperature is adjusted, to a temperature above 50° C., preferably of approximately 60° C., and to a pH above 7, preferably of approximately 8. In the present application, the term “approximately” means the value indicated ±10% of said value, preferably ±5% of said value. Of course, the exact value is included. For example, approximately 100 means between 90 and 110, preferably between 95 and 105.

These conditions are optimal for the activity of the Alcalase enzyme (for example the one sold, by the company Novozymes) which is used at a concentration of between 0.4% and 1% by dry weight, preferably 1% by dry weight.

The duration of the lysis is between 2 and 8 h, preferably 4 h.

At the end of the lysis, the applicant company recommends adding ethanol at more than 5% (v/v), preferably approximately 10%: (v/v), to the reaction mixture (oil-in-water emulsion form) and giving it stirring for a further 15 minutes.

The ethanol is added in a minor proportion to the system, as an emulsion-destabilizing agent.

The third step of the process in accordance with the invention consists in centrifuging the resulting reaction mixture in order to separate the oil from the aqueous phase.

The ethanol-destabilized emulsion obtained, at the end of the previous step is centrifuged.

Three phases are obtained:
a light upper phase (oil),
a majority aqueous intermediate phase (water+water-soluble matter), and
a lower phase (cell debris pellet).

The separation of these three phases is carried out with a three-output separator device in concentrator mode, such as the Clara 20 sold by the company Alfa Laval, which allows the recovery of the light upper phase (oil) extracted from the aqueous phase and from the cell debris.

The aqueous phase is, for its part, extracted via the heavy phase output of the separator. The solid phase is extracted via self-cleaning.

The cell lysate obtained at the end of step 2 of the process in accordance with the invention can be heated to a temperature of between 70 and 90° C., in particular between 70 and 80° C. and preferably of 80° C., and is then fed using a positive displacement pump (in order to further limit here the emulsification). Preferably, its pH can be brought to a value of between 8 and 12, preferably to a value of 10.

The centrifugal force is greater than 4000 g, preferably between 6000 and 10 000 g.

The non-emulsified light phase is preferably obtained in a single pass.

The fourth step of the process in accordance with the invention consists, finally, in recovering the squalene-enriched upper oil phase.

The invention will be understood more clearly by means of the examples which follow, which are intended to be illustrative and nonlimiting.

### EXAMPLE 1

The fermentation of the microalgae was carried out here in two successive preculturing phases before the actual culturing/production phase.

For this experiment, the vitamins were added to the first preculture medium, but addition thereof to the second preculture medium and in production was optional.

The preculture media therefore have the composition given in the following tables I and II:

TABLE I

| Medium of the first preculture | % |
|---|---|
| Glucose | 3 |
| Yeast extracts | 0.4 |
| Sodium salt of glutamic acid | 6.42 |
| NaCl | 1.25 |
| MgSO₄ | 0.4 |
| KCl | 0.05 |
| CaCl₂ | 0.01 |
| NaHCO₃ | 0.05 |
| KH₂PO₄ | 0.4 |
| Vitamin mixture | 0.14 |
| Trace elements | 0.8 |

TABLE II

| Medium of the second preculture | % |
|---|---|
| Glucose | 8.57 |
| Sodium salt of glutamic acid | 6.42 |
| Yeast extracts | 0.64 |
| NaCl | 2 |
| KH₂PO₄ | 0.64 |
| MgSO₄ | 2.29 |
| CaCl₂ | 0.03 |
| NaHCO₃ | 0.03 |
| Na₂SO₄ | 0.03 |
| Vitamin mixture | 0.14 |
| Trace elements | 0.2 |

Generally, Clerol FBA3107 antifoam was used, at 1 ml/l. Optionally, 50 mg/l of penicillin G sodium salt was used in order to prevent growth of contaminating bacteria. The glucose was sterilized with KH₂PO₄ and separately from the rest of the medium since the formation of a precipitate (Magnesium-Ammonium-Phosphate) was thus avoided. The vitamin mixture and the trace elements were added after sterilizing filtration. The composition of the culture/production medium, is given in the following table III.

TABLE III

| | % |
|---|---|
| Glucose addition at T0 | 7.5 |
| Urea | 1 |
| Yeast extracts | 1.2 |
| NaCl | 0.25 |
| KH₂PO₄ | 0.96 |
| MgSO₄ | 1.2 |
| CaCl₂ | 0.12 |
| NaHCO₃ | 0.12 |
| KCl | 0.08 |
| Addition of the vitamin mixture | 0.4 |
| Trace elements | 0.56 |

The composition of the vitamin mixtures and of the trace elements is given in the following tables IV and V:

TABLE IV

| Vitamin mixture | g/l |
|---|---|
| B1 | 45 |
| B6 | 45 |
| B12 | 0.25 |

TABLE V

| Trace elements | g/l |
|---|---|
| MnCl₂•2H₂O | 8.60 |
| CoCl2•6H₂O | 0.2 |
| NiSO₄•6H₂O | 7.50 |
| Na₂MoO₄•2H₂O | 0.15 |
| ZnSO₄•7H₂O | 5.70 |
| CnSO₄•5H₂O | 6.50 |
| FeSO₄•7H₂O | 32.00 |
| ZnCl₂ | 1.50 |

Performing the Fermentation

The first preculturing was carried out in 500 ml baffled Erlenmeyer flasks to which a drop of Clearol FBA 3107 antifoam sold, by the company Cognis GmbH Düsseldorf was added.

The culture medium was filtered after complete dissolution of its constituents, optionally supplemented with penicillin G sodium salt in a proportion of 0.25 mg/l.

The inoculation was carried out by taking colonies of microalgae cultured in a Petri dish (in a proportion of one 10 μl loop).

The incubation lasted 24 to 36 hours, at a temperature of 28° C., with snaking at 100 rpm (on an orbital shaker).

Since the biomass settles (or adheres to the wall), care was taken to sample 3 to 5 ml after having shaken the Erlenmeyer flask well.

For the second preculturing, 21 baffled Erlenmeyer flasks fitted with tubing were used.

A drop of antifoam and the yeast extract were added to 100 ml of water.

All of the constituents of the medium were filtered after dissolution in 300 ml of demineralized water. It was possible to optionally add penicillin G sodium salt and beforehand to the Erlenmeyer flask a drop of antifoam before its sterilization.

The inoculation was then carried out with 3 to 5 ml of the first preculture.

The incubation was carried, out at 28° C. for a further 24 to 36 hours, with shaking at 100 rpm.

The actual culturing was carried out in the following way in a 20 1 reactor:
sterilization of a part of the medium in the reactor, and sterilization of the other part separately so as to prevent the formation of a precipitate,
inoculation carried out using the biomass produced at the end of the second preculturing, in a proportion of 0.5% v/v of the culture medium,
culture maintained at 30° C.,
oxygen transfer rate fixed at 35-40 mmol/l/h,
aeration of 0.2 to 0.3 VVM,
initial pH >5.5,
feeding with glucose as soon as the concentration is >20%, so as to maintain a glucose concentration of between 15 and 70 g/l.

The following table IV gives the results obtained with the Schizochytrium sp. of the applicant company.

TABLE IV

| Tests | E |
|---|---|
| Preculturing temperature (° C.) | 28 |
| Culturing temperature (° C.) | 30 |
| Squalene titer at the end of | 4.4 |
| culturing (g/l) | |
| Biomass (g/l) | 54 |
| g/100 g of squalene to dry | 8.2 |
| biomass | |

Method for the Quantification of Squalene in the Schizochytrium sp. Biomass

The analysis was carried out by proton NMR at 25° C. after bead disruption of the biomass and cold extraction with chloroform/methanol. The quantification was carried out by means of an internal standard as described below.

The spectra were obtained on an Avarice III 400 spectrometer (Bruker Spectrospin), operating at 400 MHz.

Biomass disruption: Precisely weigh out approximately 200 mg of fresh biomass. Add approximately 1-1.5 cm of glass beads and 0.1 ml of methanol. Hermetically seal the tube and stir by means of a vortex mixer for at least 5 min.

Cold extraction: Add approximately 2 mg of triphenyl phosphate (TPP), 0.9 ml of methanol and 2 ml of chloroform. Hermetically seal the tube and stir by means of a vortex mixer for 1 min. Place in a refrigerator. After settling out (minimum of 1 hour), carefully recover the clear upper phase and transfer it into a glass jar for evaporation to dryness, at ambient temperature, under a nitrogen stream. Dissolve the dry extract in 0.5 ml of CDCl₃ and 0.1 ml of CD₃OD and transfer into an NMR tube.

Spectrum recording: Perform the acquisition, without solvent suppression, without rotation, with a relaxation time of at least 15 s, after having applied the appropriate settings to the instrument. The spectral window must be at least between −1 and 9 ppm with the spectrum calibrated on the chloroform peak at 7.25 ppm. Use is made of the spectrum after Fourier transformation, phase correction and subtraction of the base line in manual mode (without exponential multiplication, LB=GB=0).

Making use of the signal: Assign the value 100 to the TPP unresolved peak not containing the chloroform signal between 7.05 and 7.15 ppm (counting at 9 TPP protons). Integrate the area of the squalene signal at 1.55 ppm (singlet counting at 6 protons).

Calculation and expression of the results: The results were expressed as crude weight percentage.

$$Content = \frac{{A}_{S} \times {P}_{TPP}}{6 \times 100} \times \frac{{W}_{TPP}}{{M}_{TPP}} \times {M}_{S} \times \frac{100}{PE}$$

with
Aₛ: area of the squalene signal at 1.55 ppm
P_{TPP}: number of protons of the integrated TPP unresolved peak: 9
W_{TPP}: weight, in grams, of TPP weighed out
M_{TPP}: molar mass, in grams per mole, of the TPP (M_{TPP}=326 g/mol)
M_{S}: molar mass, in grams per mole, of the squalene (M_{S}=410 g/mol)
PE: weight, in grams, of fresh biomass

### EXAMPLE 2

### Extraction of Squalene According to the Invention

The biomass obtained at the end of example 1 was at a concentration of 54 g/l at the end of fermentation.

The squalene titer obtained at the end of fermentation was 4.4 g/l.

The biomass extracted from the fermenter is washed to remove the interstitial soluble matter via a succession of two series of concentration by centrifugation (5 minutes at 5000 g) and dilution of the biomass (in a proportion of ⅓ Vpellet/Vwater).

The dry cell concentration over the total crude dry matter content is 95%.

The dry matter content is then adjusted to 12% with distilled water.

The washed biomass is stirred in a Labo reactor of 2 1 fermenter type (such as those sold by the company Interscience) equipped, with a propeller stirrer and baffles.

This system makes it possible to limit the emulsification of the cell lysate generated while allowing good mixing which is essential for the action of the lytic enzyme.

The temperature is adjusted to 60° C. and the pH is regulated, at approximately 8 with sodium hydroxide.

These conditions are optimal for the activity of the Alcalase enzyme (Novozymes) added in an amount of 1% by dry weight.

The duration of the lysis is set at 4 h.

At the end of lysis, 10% of ethanol (Vₑₜₕₐₙₒₗ/V_{lysate}) is added to the reaction mixture (oil-in-water emulsion) kept stirring for a further 15 min.

The temperature is increased again to 80° C. and centrifugation is subsequently carried out on an Alfa Laval Clara 20 centrifugation module, configured in 3-output concentrator mode.

This configuration is particularly well suited to the separation of a three-phase mixture of solid/liquid/liquid type.

Rotation at 9600 rpm makes it possible to reach approximately 10 000 g.

The cell lysate is fed using a positive displacement pump at a flow rate of 100 to 400 l/h.

The interface between the heavy phase and the light phase is shifted by adjusting the heavy-phase output back pressure.

The frequency of self-cleaning is adjusted to a frequency of 2 to 15 min.

The crude oil was thus recovered with a yield of more than 85% and thus contains virtually all the squalene produced.

### EXAMPLE 3

### Comparative Example of Extraction of Squalene by Means of a Conventional Process with Hexane

Just as described in example 2:
The biomass obtained at the end of example 1 was at a concentration of 54 g/l at the end of fermentation.
The squalene titer obtained at the end of fermentation was 4.4 g/l.

The biomass extracted from, the fermenter is also concentrated by centrifugation at 120 g/l.

The biomass was kept stirring at 150 rpm in a 50 1 tank, and is heated to 60° C.

The pH was then adjusted to 10 using 45% potassium hydroxide.

These conditions were maintained for 6 h in order to achieve complete alkaline lysis.

The quality of the lysis was monitored under an optical microscope and by sample centrifugation (2 min, 10 000 g).

At the end of lysis, 10 liters of ethanol (1 volume of ethanol/lysate volume) were added to the tank maintained at 45° C. and stirred for 10 min. 10 liters of hexane were then added to the tank kept stirring for 30 min.

The mixture was then centrifuged in order to separate the light fraction (hexane+oil) which was stored in a 1 m³ tank.

The heavy (aqueous) phase was again placed in the presence of 10 liters of hexane so as to form a second extraction according to the same scheme as previously, in order to increase the extraction yield.

The two organic fractions were combined in order to carry out the evaporation of the hexane in a rotary evaporator.

The hexane residues of the extracted, oil were removed by evaporation using a wiped film evaporator (80° C.; 1 mbar).

The crude oil was thus recovered with a yield of 70%.

This “conventional” extraction process is therefore much less efficient than the process in accordance with the invention.

1-9. (canceled)

10. A process for extracting, without organic solvent, squalene produced by fermenting microalgae belonging to the Thraustochytriales sp. family, comprising:
a) preparing a biomass of microalgae belonging to the Thraustochytriales family so as to reduce the concentration of interstitial soluble matter, and to thus achieve a purity of between 30% and 99% expressed as the dry weight of biomass over the total dry weight of the fermentation medium,
b) treating the resulting biomass using a protease enzyme selected from the group of neutral or basic proteases so as to break the cell wall of said microalgae while preventing the formation of the emulsion produced by said enzymatic treatment,
c) centrifuging the resulting reaction mixture in order to separate the oil from the aqueous phase, and
d) recovering the squalene-enriched crude oil thus produced.

11. The process according to claim 10, wherein the biomass purified in step a) is then preferentially adjusted to a dry matter content of between 6% and 12%, preferably to a dry matter content of between 10% and 12%.

12. The process according to claim 10, wherein the enzymatic treatment of step b) is carried out with non-shearing, weakly emulsifying stirring in a device equipped with a propeller stirrer and baffles.

13. The process according to claim 10, wherein the enzymatic treatment of step b) is carried out at a temperature above 50° C. and at a pH above 7.

14. The process according to claim 12, wherein the enzymatic treatment of step b) is carried out at a temperature above 50° C. and at a pH above 7.

15. The process according to claim 10, wherein ethanol is added at the end of enzymatic treatment at more than 5% (v/v).

16. The process according to claim 15, wherein the ethanol treatment is carried out with stirring for more than 10 minutes.

17. The process according to claim 12, wherein ethanol is added at the end of enzymatic treatment at more than 5% (v/v).

18. The process according to claim 17, wherein the ethanol treatment is carried out with stirring for more than 10 minutes.

19. The process according to claim 13, wherein ethanol is added at the end of enzymatic treatment at more than 5% (v/v).

20. The process according to claim 19, wherein the ethanol treatment is carried out with stirring for more than 10 minutes.

21. The process according to claim 10, wherein the reaction mixture is at a temperature of between 70 and 90° C. and its pH is brought to a value of between 8 and 12 before the centrifugation.

22. The process according to claim 14, wherein the reaction mixture is at a temperature of between 70 and 90° C. and its pH is brought to a value of between 8 and 12 before the centrifugation.

23. The process according to claim 10, wherein the centrifugation is carried out in a three-output separator in concentrator mode which allows the recovery of the light upper phase (oil) extracted from the aqueous phase and from the cell debris.

24. The process according to claim 23, wherein the centrifugation is carried out with a centrifugal force of greater than 4000 g.
